(19) United States
(12) Patent Application Publication
(10) Pub. No.: US 2014/0093859 A1
(43) Pub. Date: Apr. 3, 2014

(54) Intelligence Crawling Pad

(71) Applicant: Ning Zhang, Markham (CA)

(72) Inventor: Ning Zhang, Markham (CA)

(21) Appl. No.: 13/630,761

(22) Filed: Sep. 28, 2012

(51) Int. Cl. G09B 19/00

(52) U.S. Cl. 434/365

(57) ABSTRACT

The invention is a crawling pad for the babies with a replaceable intelligence patch. The characteristic lies in: The crawling pad is divided into several areas based on different colorful design with allocated pockets by suture. The LED lamination and sound chips formed an intelligence patch can be inserted into individual pocket on the pad. The inserted intelligence patch comprises of: printed circuit board, LED lamination, sound chip and a controller with the automatic time-delay switch. All these components are set inside a fully heat-sealed patch that is formed: a printed decorative vinyl cover; then a soft lining on top of the electronic components; and the bottom is a clear/solid color vinyl. The bright patterns and sound enhance the cause and effect development to the babies at their early age. The variety choices of changeable patch with different patterns and sound empower the babies gaining new knowledge over time.

### TECHNICAL FIELD

This invention is an intelligence crawling pad for babies, pertaining to the development of the intelligence for babies.

### BACKGROUND

Most of the conventional crawling pad in the market are the ones only with printed patterns on the pad, though a few of which can give out light and sound. All of the patterns and devices emitting light and sound are fixed and non-replaceable. If more knowledge wants to be gained through the crawling pad, the whole pad has to be replaced, causing higher cost inevitably.

The drawbacks of the crawling pad currently used with light and sound are: 1. The pattern is monotonous and dull. 2. The wire is connected with a big battery box or power supply unit outside, which is heavy, bulky and maybe harmful to the babies, i.e.; babies may bump their heads on the hard surface and get hurt themselves.

Based on the above-mentioned, a crawling pad with LED light and sound inserted patch has been invented. The invention aims to stimulate the babies' visual sense and promote self-awareness while they move around the pad. It draws the babies' attention and interests by contacting the patterns of words, numbers, light and sound when they crawl on their tummies. The pad is easy to care, fold and go. It is machine washable.

### CONTENT

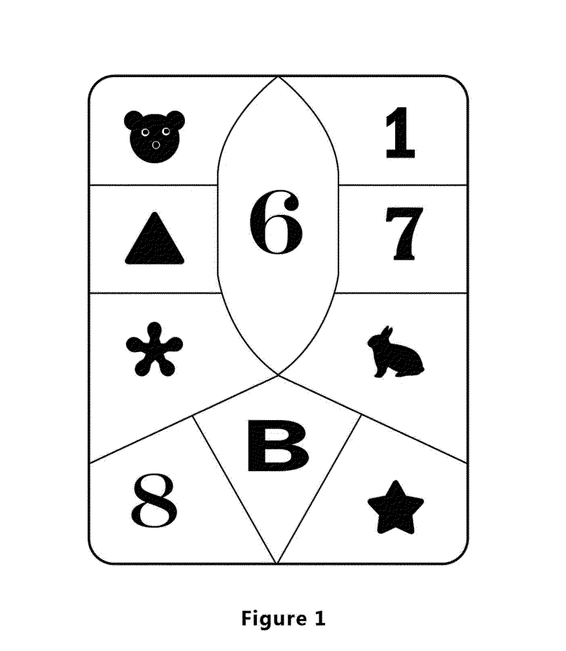

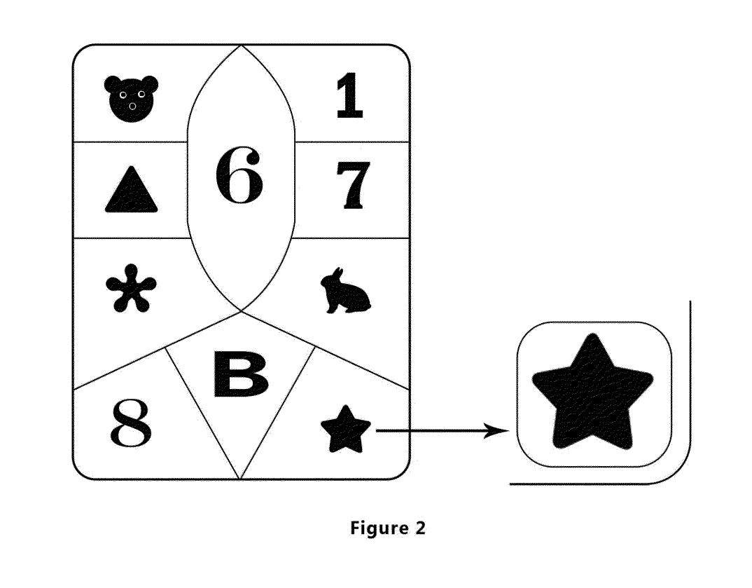

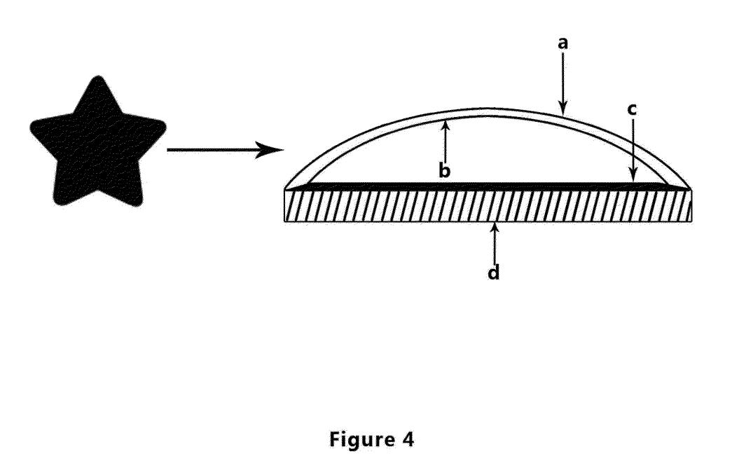

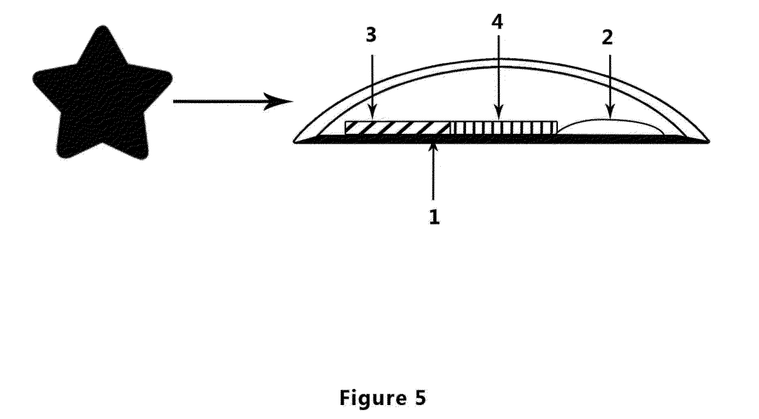

1. The intelligence crawling pad, basically made by cotton, or soft polyester, or other softly treated fabric, it is safe to the skin of babies. It comprises the upper layer and bottom layer with 4 sides sewn up. The upper layer of the pad is divided into several areas based on different kinds of colorful pattern by suture. Pockets with different shapes are designed for each area for the insertion of patches (FIG. 1). The bottom part is one piece of solid color fabric.
2. The pocket on the crawling pad is a transparency vinyl so that the inserted intelligence patch can be seen from the outside (FIG. 2). 3 sides of the pocket are sewn up and one side is left open for insertion or replacement of the intelligence patch; and the opening will be sealed with zipper or Velcro.
3. The reason of designed pocket in particular for the insertion of intelligence patch instead of attaching it directly to the pad with the Velcro is that it can protect the baby from being hurt by the potential roughness of patch.
4. The intelligence patch has 4 layers:
   (a) the upper layer is a decorative printed vinyl cover;
   (b) the second layer is a filler made of soft material like glued sponge;
   (c) the circuit board with electronic components is underneath the filler;
   (d) the bottom layer is a clear/solid color vinyl.
      The intelligence patch is fully heat-sealed together so as to prevent the electronic components from being damaged by water or urine (FIG. 4). The intelligence patch is waterproof and can be washable.
5. The electronic components for this intelligence patch comprises of: (1) printed circuit board. (2) LED laminator (3) sound chip (4) automatic time-delay switch controlling the light and sound. Please refer FIG. 5 for details.
6. The color of light can be any color; and the sound can be any kinds subject to the design or shapes on the pad. For instance, it can be a piece of music; or can be bird twittering for the design of a little bird; or the pronunciation of the numbers for the design of numbers. The choices are enormous.
7. The intelligence patch is designed with an automatic time-delay switch which will be turned on when the baby touches it while crawling. The LED lamination will emit light and the chip will give out sound. Light and sound will last at a pre-set time frame; say 10 seconds; but not limited to 10 seconds, then the power will be off automatically. When the baby touches it again, another round of game will start. The battery will have longer life span with the automatic time-delay switch.
8. There are variety choices of the intelligence patches for selection. The pockets are prepared for the patch replacements after one round of game for a certain period of time. The pad can be used for an extended time as more educational training options are available for the babies.

### BRIEF DESCRIPTION OF THE DRAWINGS

Attached FIG. 1:

The complete view of the crawling pad which is divided into several areas where pockets with the intelligence patch can be inserted.

Attached FIG. 2:

The enlarged view of the pocket and partial view of the intelligence patch of star shape inserted, which can be seen through the transparent cover.

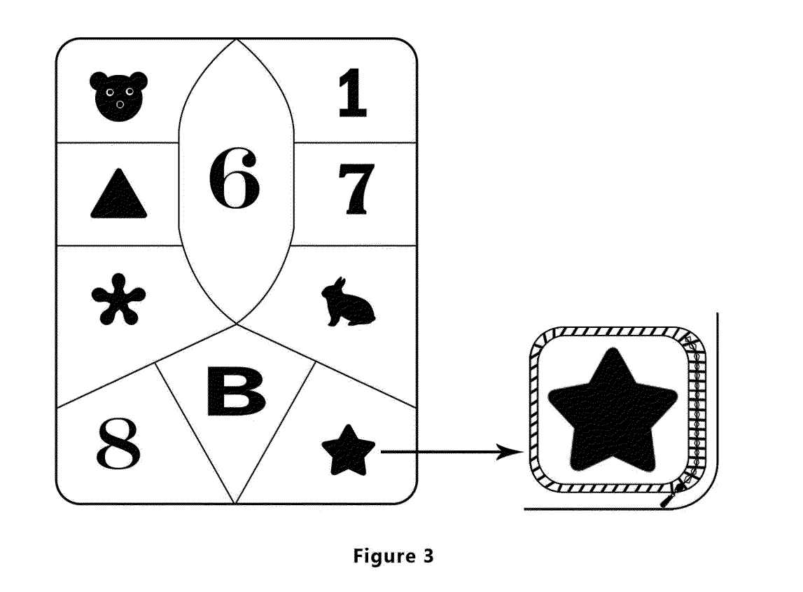

Attached FIG. 3:

The view of the pocket, 3 sides of which are fixed by suture, and 1 side is zipper or Velcro which is used for opening and closing for changing the intelligence patch.

Attached FIG. 4:

The side view of the external structure of the intelligence patch:
(a) the upper layer is a decorative printed vinyl cover;
(b) the second layer is a filler made of soft material like glued sponge;
(c) the circuit board with electronic components is underneath the filler;
(d) the bottom layer is a clear/solid color vinyl.
   The intelligence patch is fully heat-sealed. It is waterproof.

Attached FIG. 5:

The view of the structure of electric components (1) printed circuit board. (2) LED light (3) sound chip (4) automatic time-delay switch controlling the light and sound.

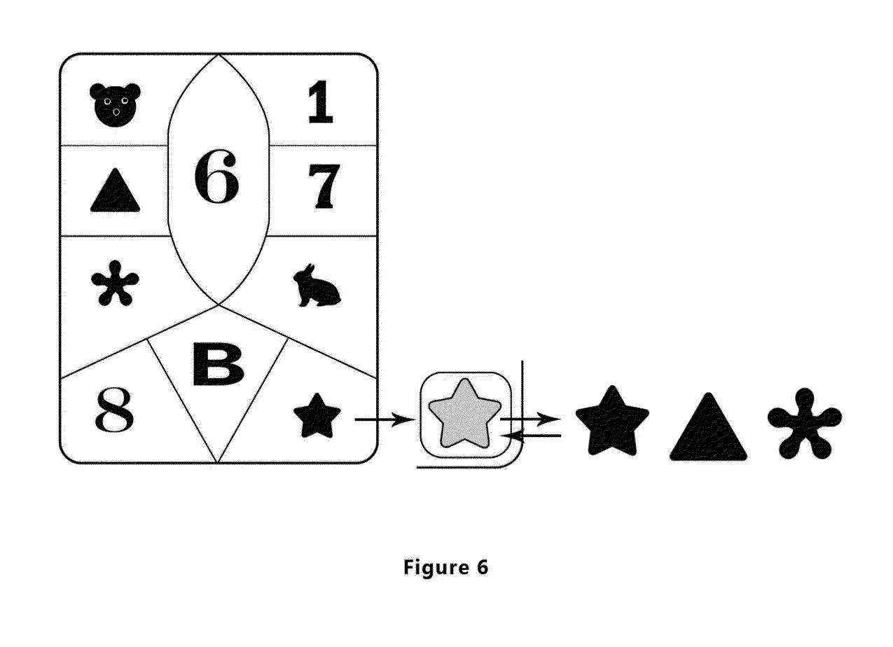

Attached FIG. 6:

The view of changing the intelligence patches, which can be any shape such as tetragon or diamond. The light and sound is subject to the theme of the designs.

### DESCRIPTION OF APPLICATION

Referring to the attached FIG. 1, spread the crawling pad flat first and insert the intelligence patch into the desired pocket, then close it with the zipper or the Velcro before putting the baby on the pad. When the baby is crawling around, it will touch the automatic time-delay switch and the power will be on, light and sound will be emitted, which will attract the baby's attention and interest. As a result, the baby is not only self-entertaining himself but also stimulate the intelligence training through the repeated actions of activities.

After using the crawling pad for a certain period of time, you can simply change a new series of different intelligence patches to arouse the baby's interest of which provide more educational training available to the little one. You can have numerous choices of different information by using one pad repetitively as long as you keep changing the intelligence patches.

1. A crawling pad with changeable intelligence patches inserted inside individual pocket, the characteristic lies in that: the pad has bright and colorful patterns divided by suture, with LED lamination and sound chips formed an intelligence patch inserted into individual pocket allocated on the pad. The intelligence patch comprises: printed circuit board, LED lamination, sound chips and a controller circuit with an automatic time-delay switch. All these components are set inside a fully heat-sealed patch that is formed of: a decorative printed vinyl surface;
then a soft lining on top of the electronic components; and the bottom is a clear/solid color vinyl. The intelligence patch is replaceable.

2. According to claimed 1, the crawling pad has contains two layers: the top layer has bright and colorful patterns divided into different areas by the suture; the bottom layer is a matching solid color fabric, all 4 sides are fixed by sewing line.

3. According to claim 1, on the top layer of the crawling pad, individual transparency vinyl pocket is allocated amongst the divided area. 3 sides of the pocket are fixed by sewing line and one side is open for inserting the intelligence patch.

4. According to claim 1, the intelligence patches can be inserted into each transparency vinyl pockets which can be either sealed with a zipper or Velcro.

5. According to claim 1, the intelligence patch has 4 layers: the upper layer is a decorative printed vinyl cover; the second layer is a lining made of soft material like glued sponge; the electronic component is underneath the lining and the bottom layer is a clear/solid vinyl cover. The patch is fully heat-sealed around the edges and is waterproof.

6. According to claim 1, the structure of the intelligence patch comprises: printed circuit board where laminator LED and sound chips are set and light and sound are controlled by the automatic time-delay switch.

7. According to claim 1, the color of light of the intelligence patch can be any color.

8. According to claim 1, the sound of the intelligence patch can be any pieces of music, voice of animals, numbers, alphabets, or any other kinds of vocalization.
